(19) United States
(12) Patent Application Publication
(10) Pub. No.: US 2025/0028586 A1
(43) Pub. Date: Jan. 23, 2025

(54) REAL-TIME BIDIRECTIONAL COMMUNICATION BETWEEN ROBOTIC PROCESS AUTOMATION (RPA) ROBOTS AND A WEB APPLICATION

(71) Applicant: UiPath, Inc., New York, NY (US)

(72) Inventors: Venkata SUBRAMANIAN, Bengaluru (IN); Suhail Ahmad SIDDIQI, Bangalore (IN); Arghya CHAKRABARTY, Kolkata (IN); Tudor Andrei ERGHELEGIU, Bucharest (RO); Radu OANCEA, Voineasa (RO); Bogdan RIPA, Bucharest (RO)

(73) Assignee: UiPath, Inc., New York, NY (US)

(21) Appl. No.: 18/470,137

(22) Filed: Sep. 19, 2023

(30) Foreign Application Priority Data
Jul. 21, 2023 (IN) 202311049273

(51) Int. Cl. G06F 9/54

(52) U.S. Cl. CPC G06F 9/547

(57) ABSTRACT

To performing real-time bidirectional communication between robotic process automation (RPA) robots and a web application, a robot initiates execution of a primary workflow when a request is received from a web application. The robot then listens for one or more triggers from the web application to start execution of a secondary workflow, and executes the secondary workflow when the one or more triggers are detected. The robot also returns a result of the execution of the secondary workflow to the web application.

### CROSS-REFERENCE TO RELATED APPLICATION

This application claims the benefit of, and priority to, Indian patent application No. 202311049273, filed on Jul. 21, 2023. The subject matter thereof is hereby incorporated herein by reference in its entirety.

### FIELD

The present invention generally relates to robotic process automation (RPA), and more specifically, to performing real-time bidirectional communication between RPA robots and a web application.

### BACKGROUND

When a process is executed, it takes significant time for a RPA robot to initiate and start automation of the process. For example, every time a process is executed, the RPA robot downloads all the dependencies and/or setups initial requirements in order to execute the workflow. In other words, when a RPA robot performs work on a web application, a new process must be executed, leading to an increase in network and processing time.

During execution of the process, the user cannot send an input to the process from the web application due to the communication gap between the web application and the process, which is executed by the robot. For instance, when the user wants to provide one or more additional inputs to the process, a new process must be started since the input to the process can only be provided prior to executing the process.

Currently, UiPath® Apps (or web applications) allow a user to infer automations/process. In one example, a user may configure a button, which calls a process from the web application. The process called from the web application may receive one or more inputs prior to executing the process. Let's assume, for example, that an application has five input fields. In this example, the five input fields may be considered as a single input to the process, which is called by a corresponding element (e.g., a button) of the web application.

The button, when clicked on, may retrieve (or call) a process and the data filled into the five fields, in this example, is submitted as a single input to the called process. After the process is executed, the results are displayed on the application. If, however, the process encounters an error during the execution of the process, the error is reported.

Because there is no bidirectional communication between the web application and the RPA robot upon execution of the process, the process would have to be restarted if additional inputs are sent during execution of the process. Accordingly, an improved approach to enabling bidirectional communication between the robots and the web application may be beneficial.

### SUMMARY

Certain embodiments of the present invention may provide solutions to the problems and needs in the art that have not yet been fully identified, appreciated, or solved by current RPA technologies. For example, some embodiments of the present invention pertain to a real-time bidirectional communication between a Robotic Process Automation (RPA) enabled web application and a robot executing a RPA process.

In an embodiment, one or more non-transitory computer-readable media store one or more computer programs. The one or more computer programs are configured to cause at least one processor to execute initiating, by a robot, execution of a primary workflow when a request is received from a web application. The robot is in an attended mode or an unattended mode. The one or more computer programs are further configured to cause at least one processor to execute listening, by the robot, for one or more triggers from the web application to start execution of a secondary workflow, and executing, by the robot, the secondary workflow when the one or more triggers are detected. The one or more computer programs are further configured to cause at least one processor to execute returning, by the robot, a result of the execution of the secondary workflow to the web application. The communication between the robot and the web application is instantaneous and bi-directional.

In another embodiment, an apparatus includes at least one processor and memory comprising a set of instructions. The set of instructions are configured to cause the at least one processor to execute initiating, by a robot, execution of a primary workflow when a request is received from a web application and listening, by the robot, for one or more triggers from the web application to start execution of a secondary workflow. The robot may be in an attended mode or an unattended mode. The set of instructions are further configured to cause the at least one processor to execute executing, by the robot, the secondary workflow when the one or more triggers are detected, and returning, by the robot, a result of the execution of the secondary workflow to the web application. The communication between the robot and the web application is instantaneous and bi-directional.

In yet another embodiment, a computer-implemented method includes initiating, by a robot, execution of a primary workflow when a request is received from a web application, where the robot is in an attended mode or an unattended mode. The computer-implemented method also includes listening, by the robot, for one or more triggers from the web application to start execution of a secondary workflow, and executing, by the robot, the secondary workflow when the one or more triggers are detected. The computer-implemented method further includes returning, by the robot, a result of the execution of the secondary workflow to the web application. The communication between the robot and the web application is instantaneous and bi-directional.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is an architectural diagram illustrating a hyper-automation system, according to an embodiment of the present invention.

FIG. 2 is an architectural diagram illustrating an RPA system, according to an embodiment of the present invention.

FIG. 3 is an architectural diagram illustrating a deployed RPA system, according to an embodiment of the present invention.

FIG. 4 is an architectural diagram illustrating the relationship between a designer, activities, and drivers, according to an embodiment of the present invention.

FIG. 5 is an architectural diagram illustrating a computing system configured to provide a design time AI/ML recommendation engine for RPA, according to an embodiment of the present invention.

FIG. 6 is a diagram illustrating a system for real-time communication by an attended robot, according to an embodiment of the present invention.

FIG. 7 is a diagram illustrating a system for real-time communication by an unattended robot, according to an embodiment of the present invention.

FIG. 8 is a flow diagram illustrating a process for performing real-time bidirectional communication between RPA robots and a web application, according to an embodiment of the present invention.

Unless otherwise indicated, similar reference characters denote corresponding features consistently throughout the attached drawings.

### DETAILED DESCRIPTION OF THE EMBODIMENTS

Some embodiments generally pertain to a real-time bidirectional communication between a Robotic Process Automation (RPA) enabled web application and a robot executing a RPA process. Bidirectional communication may be implemented on a web infrastructure, such as JavaScript™, WebSocket™, etc., and an UiPath® platform using event-based triggers and messaging.

In an embodiment, when the web application sends a request to a robot to initiate a process, the robot may start to execute the process. The process may include multiple sub-processes (e.g., XAML files/workflows). Once the process starts, a trigger monitor listens for one or more inputs (or one or more trigger events) from the web application to start the execution of workflow (i.e., sub-process). The inputs to the robot to start the sub-process includes a workflow identifier and workflow input parameters. A workflow identifier is defined as a string (or text) that uniquely identifies a workflow XAML, which is practically the file path of the XAML. Workflow input parameters are defined as input data that is needed to run or execute a specified workflow. The trigger event is the invocation of the sub-process by the web applicated initiated by user or through some changes in application as configured. The web application may communicate with the process to initiate the workflows at any time when the process is running. The results are returned to the web applications after each workflow is executed. Thus, enabling real-time bidirectional communication between the web application and the robot.

There are two type of automation-attended automation and unattended automation. With attended automation, the web application service may send a message to the robot along with the input(s) for initiating the process. With unattended automation, the web application service may send a communication, along with input(s), to Orchestrator™. Upon receipt of the communication, Orchestrator™ sends a message to robot for execution of the process.

With this embodiment, the web application can start one process with multiple sub-processes (in workflows), and get additional tasks accomplished by just invoking one of those sub-processes. The robot, in this embodiments, continues to execute the main process while waiting for incoming commands from the web application. The web application may start a sub-process (i.e., a workflow) by sending a command. Robot may then execute the command and return the results of the sub-processes to the web application. This effectively removes the need to run a brand new process for each task.

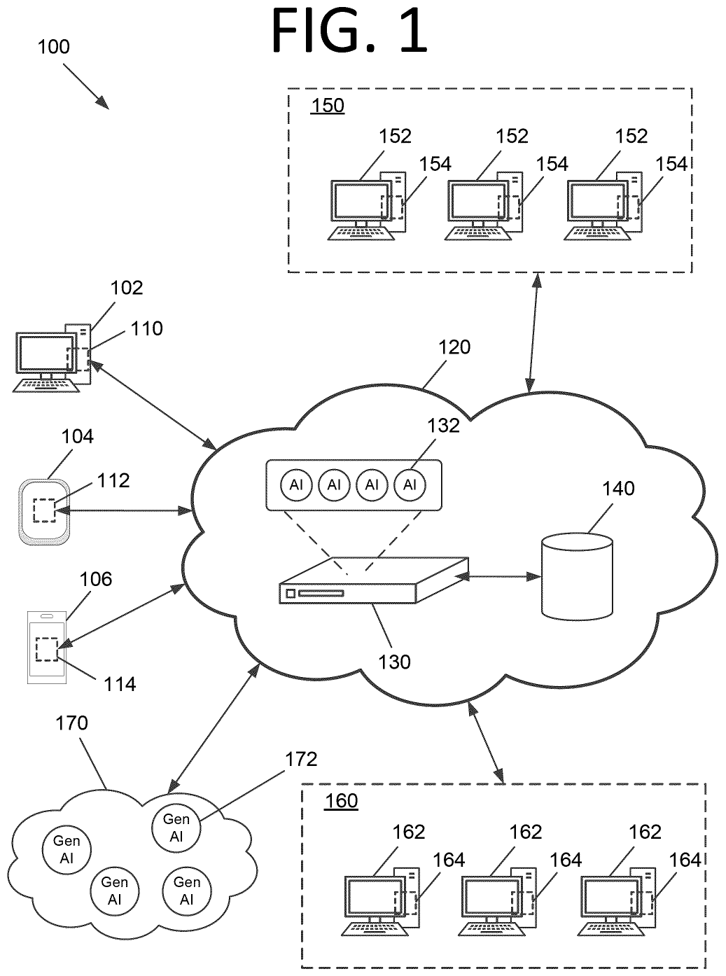

FIG. 1 is an architectural diagram illustrating a hyper-automation system 100, according to an embodiment of the present invention. “Hyper-automation,” as used herein, refers to automation systems that bring together components of process automation, integration tools, and technologies that amplify the ability to automate work. For instance, RPA may be used at the core of a hyper-automation system in some embodiments, and in certain embodiments, automation capabilities may be expanded with AI/ML, process mining, analytics, and/or other advanced tools. As the hyper-automation system learns processes, trains AI/ML models, and employs analytics, for example, more and more knowledge work may be automated, and computing systems in an organization, e.g., both those used by individuals and those that run autonomously, may all be engaged to be participants in the hyper-automation process. Hyper-automation systems of some embodiments allow users and organizations to discover, understand, and scale automations efficiently and effectively.

Hyper-automation system 100 includes user computing systems, such as desktop computer 102, tablet 104, and smart phone 106. However, any desired user computing system may be used without deviating from the scope of the invention including, but not limited to, smart watches, laptop computers, servers, Internet-of-Things (IoT) devices, etc. Also, while three user computing systems are shown in FIG. 1, any suitable number of user computing systems may be used without deviating from the scope of the invention. For instance, in some embodiments, dozens, hundreds, thousands, or millions of user computing systems may be used. The user computing systems may be actively used by a user or run automatically without much or any user input.

Each user computing system 102, 104, 106 has respective automation process(es) 110, 112, 114 running thereon. In some embodiments, the automation processes are stored remotely (e.g., on server 130 or in database 140 and accessed via network 120) and loaded by RPA robots to implement the automation. Automations may exist as a script (e.g., XML, XAML, etc.) or be compiled into machine readable code (e.g., as a dynamic link library).

Automation process(es) 110, 112, 114 may include, but are not limited to, RPA robots, part of an operating system, downloadable application(s) for the respective computing system, any other suitable software and/or hardware, or any combination of these without deviating from the scope of the invention. In some embodiments, one or more of process(es) 110, 112, 114 may be listeners. Listeners may be RPA robots, part of an operating system, a downloadable application for the respective computing system, or any other software and/or hardware without deviating from the scope of the invention. Indeed, in some embodiments, the logic of the listener(s) is implemented partially or completely via physical hardware.

Listeners monitor and record data pertaining to user interactions with respective computing systems and/or operations of unattended computing systems and send the data to a core hyper-automation system 120 via a network (e.g., a local area network (LAN), a mobile communications network, a satellite communications network, the Internet, any combination thereof, etc.). The data may include, but is not limited to, which buttons were clicked, where a mouse was moved, the text that was entered in a field, that one window was minimized and another was opened, the application associated with a window, etc. In certain embodiments, the data from the listeners may be sent periodically as part of a heartbeat message. In some embodiments, the data may be sent to core hyper-automation system 120 once a predetermined amount of data has been collected, after a predetermined time period has elapsed, or both. One or more servers, such as server 130, receive and store data from the listeners in a database, such as database 140.

Automation processes may execute the logic developed in workflows during design time. In the case of RPA, workflows may include a set of steps, defined herein as “activities,” that are executed in a sequence or some other logical flow. Each activity may include an action, such as clicking a button, reading a file, writing to a log panel, etc. In some embodiments, workflows may be nested or embedded.

Long-running workflows for RPA in some embodiments are master projects that support service orchestration, human intervention, and long-running transactions in unattended environments. See, for example, U.S. Pat. No. 10,860,905, which is hereby incorporated by reference in its entirety. Human intervention comes into play when certain processes require human input to handle exceptions, approvals, or validation before proceeding to the next step in the activity. In this situation, the process execution is suspended, freeing up the RPA robots until the human task is completed.

A long-running workflow may support workflow fragmentation via persistence activities and may be combined with invoke process and non-user interaction activities, orchestrating human tasks with RPA robot tasks. In some embodiments, multiple or many computing systems may participate in executing the logic of a long-running workflow. The long-running workflow may run in a session to facilitate speedy execution. In some embodiments, long-running workflows may orchestrate background processes that may contain activities performing Application Programming Interface (API) calls and running in the long-running workflow session. These activities may be invoked by an invoke process activity in some embodiments. A process with user interaction activities that runs in a user session may be called by starting a job from a conductor activity (conductor described in more detail later herein). The user may interact through tasks that require forms to be completed in the conductor in some embodiments. Activities may be included that cause the RPA robot to wait for a form task to be completed and then resume the long-running workflow.

One or more of automation process(es) 110, 112, 114 is in communication with core hyper-automation system 120. In some embodiments, core hyper-automation system 120 may run a conductor application on one or more servers, such as server 130. While one server 130 is shown for illustration purposes, multiple or many servers that are proximate to one another or in a distributed architecture may be employed without deviating from the scope of the invention. For instance, one or more servers may be provided for conductor functionality, AI/ML model serving, authentication, governance, and or any other suitable functionality without deviating from the scope of the invention. In some embodiments, core hyper-automation system 120 may incorporate or be part of a public cloud architecture, a private cloud architecture, a hybrid cloud architecture, etc. In certain embodiments, core hyper-automation system 120 may host multiple software-based servers on one or more computing systems, such as server 130. In some embodiments, one or more servers of core hyper-automation system 120, such as server 130, may be implemented via one or more virtual machines (VMs).

In some embodiments, one or more of automation process(es) 110, 112, 114 may call one or more AI/ML models 132 deployed on or accessible by core hyper-automation system 120 and trained to accomplish various tasks. For instance, AI/ML models 132 may include models trained to look for various application versions, perform CV, generate UI descriptors, offer suggestions for next activities or sequences of activities in RPA workflows, etc. AI/ML models may be trained using labeled data that includes, but is not limited to, previously created RPA workflows, screenshots of various application screens for various versions with their corresponding UI elements, libraries of UI objects, etc. AI/ML models 132 may be trained to achieve a desired confidence threshold while not being overfit to a given set of training data.

AI/ML models 132 may be trained for any suitable purpose without deviating from the scope of the invention, as will be discussed in more detail later herein. Two or more of AI/ML models 132 may be chained in some embodiments (e.g., in series, in parallel, or a combination thereof) such that they collectively provide collaborative output(s). AI/ML models 132 may perform or assist with CV, OCR, document processing and/or understanding, semantic learning and/or analysis, analytical predictions, process discovery, task mining, testing, automatic RPA workflow generation, sequence extraction, clustering detection, audio-to-text translation, any combination thereof, etc. However, any desired number and/or type(s) of AI/ML models may be used without deviating from the scope of the invention. Using multiple AI/ML models may allow the system to develop a global picture of what is happening on a given computing system, for example. For instance, one AI/ML model could perform OCR, another could detect buttons, another could compare sequences, etc. Patterns may be determined individually by an AI/ML model or collectively by multiple AI/ML models. In certain embodiments, one or more AI/ML models are deployed locally on at least one of computing systems 102, 104, 106.

In some embodiments, multiple AI/ML models 132 may be used. Each AI/ML model 132 is an algorithm (or model) that runs on the data, and the AI/ML model itself may be a deep learning neural network (DLNN) of trained artificial “neurons” that are trained on training data, for example. In some embodiments, AI/ML models 132 may have multiple layers that perform various functions, such as statistical modeling (e.g., hidden Markov models (HMMs)), and utilize deep learning techniques (e.g., long short term memory (LSTM) deep learning, encoding of previous hidden states, etc.) to perform the desired functionality.

Hyper-automation system 100 may provide four main groups of functionality in some embodiments: (1) discovery; (2) building automations; (3) management; and (4) engagement. Automations (e.g., run on a user computing system, a server, etc.) may be run by software robots, such as RPA robots, in some embodiments. For instance, attended robots, unattended robots, and/or test robots may be used. Attended robots work with users to assist them with tasks (e.g., via UiPath Assistant™). Unattended robots work independently of users and may run in the background, potentially without user knowledge. Test robots are unattended robots that run test cases against applications or RPA workflows. Test robots may be run on multiple computing systems in parallel in some embodiments.

The discovery functionality may discover and provide automatic recommendations for different opportunities of automation of business processes. Such functionality may be implemented by one or more servers, such as server 130. The discovery functionality may include providing an automation hub, process mining, task mining, and/or task capture in some embodiments. The automation hub (e.g., UiPath Automation Hub™) may provide a mechanism for managing automation rollout with visibility and control. Automation ideas may be crowdsourced from employees via a submission form, for example. Feasibility and return on investment (ROI) calculations for automating these ideas may be provided, documentation for future automations may be collected, and collaboration may be provided to get from automation discovery to build-out faster.

Process mining (e.g., via UiPath Automation Cloud™ and/or UiPath AI Center™) refers to the process of gathering and analyzing the data from applications (e.g., enterprise resource planning (ERP) applications, customer relation management (CRM) applications, email applications, call center applications, etc.) to identify what end-to-end processes exist in an organization and how to automate them effectively, as well as indicate what the impact of the automation will be. This data may be gleaned from user computing systems 102, 104, 106 by listeners, for example, and processed by servers, such as server 130. One or more AI/ML models 132 may be employed for this purpose in some embodiments. This information may be exported to the automation hub to speed up implementation and avoid manual information transfer. The goal of process mining may be to increase business value by automating processes within an organization. Some examples of process mining goals include, but are not limited to, increasing profit, improving customer satisfaction, regulatory and/or contractual compliance, improving employee efficiency, etc.

Task mining (e.g., via UiPath Automation Cloud™ and/or UiPath AI Center™) identifies and aggregates workflows (e.g., employee workflows), and then applies AI to expose patterns and variations in day-to-day tasks, scoring such tasks for ease of automation and potential savings (e.g., time and/or cost savings). One or more AI/ML models 132 may be employed to uncover recurring task patterns in the data. Repetitive tasks that are ripe for automation may then be identified. This information may initially be provided by listeners and analyzed on servers of core hyper-automation system 120, such as server 130, in some embodiments. The findings from task mining (e.g., Extensible Application Markup Language (XAML) process data) may be exported to process documents or to a designer application such as UiPath Studio™ to create and deploy automations more rapidly.

Task mining in some embodiments may include taking screenshots with user actions (e.g., mouse click locations, keyboard inputs, application windows and graphical elements the user was interacting with, timestamps for the interactions, etc.), collecting statistical data (e.g., execution time, number of actions, text entries, etc.), editing and annotating screenshots, specifying types of actions to be recorded, etc.

Task capture (e.g., via UiPath Automation Cloud™ and/or UiPath AI Center™) automatically documents attended processes as users work or provides a framework for unattended processes. Such documentation may include desired tasks to automate in the form of process definition documents (PDDs), skeletal workflows, capturing actions for each part of a process, recording user actions and automatically generating a comprehensive workflow diagram including the details about each step, Microsoft Word® documents, XAML files, and the like. Build-ready workflows may be exported directly to a designer application in some embodiments, such as UiPath Studio™. Task capture may simplify the requirements gathering process for both subject matter experts explaining a process and CoE members providing production-grade automations.

Building automations may be accomplished via a designer application (e.g., UiPath Studio™, UiPath StudioX™, or UiPath Web™). For instance, RPA developers of an RPA development facility 150 may use RPA designer applications 154 of computing systems 152 to build and test automations for various applications and environments, such as web, mobile, SAP®, and virtualized desktops. API integration may be provided for various applications, technologies, and platforms. Predefined activities, drag-and-drop modeling, and a workflow recorder, may make automation easier with minimal coding. Document understanding functionality may be provided via Drag-and-drop AI skills for data extraction and interpretation that call one or more AI/ML models 132. Such automations may process virtually any document type and format, including tables, checkboxes, signatures, and handwriting. When data is validated or exceptions are handled, this information may be used to retrain the respective AI/ML models, improving their accuracy over time.

RPA designer application 152 may be designed to call one or more of trained AI/ML models 132 on server 130 and/or generative AI models 172 in a cloud environment via network 120 (e.g., a local area network (LAN), a mobile communications network, a satellite communications network, the Internet, any combination thereof, etc.) to assist with the RPA automation development process. In some embodiments, one or more of the AI/ML models may be packaged with RPA designer application 152 or otherwise stored locally on computing system 150.

In some embodiments, RPA designer application 152 and one or more of AI/ML models 132 may be configured to use an object repository stored in database 140. The object repository may include libraries of UI objects that can be used to develop RPA workflows via RPA designer application 152. The object repository may be used to add UI descriptors to activities in the workflows of RPA designer application 152 for UI automations. In some embodiments, one or more of AI/ML models 132 may generate new UI descriptors and add them to the object repository in database 140. Once automations are completed in designer application 152, they may be published on server 130, pushed out to computing systems 102, 104, 106, etc.

An integration service may allow developers to seamlessly combine user interface (UI) automation with API automation, for example. Automations may be built that require APIs or traverse both API and non-API applications and systems. A repository (e.g., UiPath Object Repository™) or marketplace (e.g., UiPath Marketplace™) for pre-built RPA and AI templates and solutions may be provided to allow developers to automate a wide variety of processes more quickly. Thus, when building automations, hyper-automation system 100 may provide user interfaces, development environments, API integration, pre-built and/or custom-built AI/ML models, development templates, integrated development environments (IDEs), and advanced AI capabilities. Hyper-automation system 100 enables development, deployment, management, configuration, monitoring, debugging, and maintenance of RPA robots in some embodiments, which may provide automations for hyper-automation system 100.

In some embodiments, components of hyper-automation system 100, such as designer application(s) and/or an external rules engine, provide support for managing and enforcing governance policies for controlling various functionality provided by hyper-automation system 100. Governance is the ability for organizations to put policies in place to prevent users from developing automations (e.g., RPA robots) capable of taking actions that may harm the organization, such as violating the E.U. General Data Protection Regulation (GDPR), the U.S. Health Insurance Portability and Accountability Act (HIPAA), third party application terms of service, etc. Since developers may otherwise create automations that violate privacy laws, terms of service, etc. while performing their automations, some embodiments implement access control and governance restrictions at the robot and/or robot design application level. This may provide an added level of security and compliance into to the automation process development pipeline in some embodiments by preventing developers from taking dependencies on unapproved software libraries that may either introduce security risks or work in a way that violates policies, regulations, privacy laws, and/or privacy policies. See, for example, U.S. Patent Application Publication No. 2022/0011732, which is hereby incorporated by reference in its entirety.

The management functionality may provide management, deployment, and optimization of automations across an organization. The management functionality may include orchestration, test management, AI functionality, and/or insights in some embodiments. Management functionality of hyper-automation system 100 may also act as an integration point with third-party solutions and applications for automation applications and/or RPA robots. The management capabilities of hyper-automation system 100 may include, but are not limited to, facilitating provisioning, deployment, configuration, queuing, monitoring, logging, and interconnectivity of RPA robots, among other things.

A conductor application, such as UiPath Orchestrator™ (which may be provided as part of the UiPath Automation Cloud™ in some embodiments, or on premises, in VMs, in a private or public cloud, in a Linux™ VM, or as a cloud native single container suite via UiPath Automation Suite™), provides orchestration capabilities to deploy, monitor, optimize, scale, and ensure security of RPA robot deployments. A test suite (e.g., UiPath Test Suite™) may provide test management to monitor the quality of deployed automations. The test suite may facilitate test planning and execution, meeting of requirements, and defect traceability. The test suite may include comprehensive test reporting.

Analytics software (e.g., UiPath Insights™) may track, measure, and manage the performance of deployed automations. The analytics software may align automation operations with specific key performance indicators (KPIs) and strategic outcomes for an organization. The analytics software may present results in a dashboard format for better understanding by human users.

A data service (e.g., UiPath Data Service™) may be stored in database 140, for example, and bring data into a single, scalable, secure place with a drag-and-drop storage interface. Some embodiments may provide low-code or no-code data modeling and storage to automations while ensuring seamless access, enterprise-grade security, and scalability of the data. AI functionality may be provided by an AI center (e.g., UiPath AI Center™), which facilitates incorporation of AI/ML models into automations. Pre-built AI/ML models, model templates, and various deployment options may make such functionality accessible even to those who are not data scientists. Deployed automations (e.g., RPA robots) may call AI/ML models from the AI center, such as AI/ML models 132. Performance of the AI/ML models may be monitored, and be trained and improved using human-validated data, such as that provided by data review center 160. Human reviewers may provide labeled data to core hyper-automation system 120 via a review application 152 on computing systems 154. For instance, human reviewers may validate that predictions by AI/ML models 132 are accurate or provide corrections otherwise. This dynamic input may then be saved as training data for retraining AI/ML models 132, and may be stored in a database such as database 140, for example. The AI center may then schedule and execute training jobs to train the new versions of the AI/ML models using the training data. Both positive and negative examples may be stored and used for retraining of AI/ML models 132.

The engagement functionality engages humans and automations as one team for seamless collaboration on desired processes. Low-code applications may be built (e.g., via UiPath Apps™) to connect browser tabs and legacy software, even that lacking APIs in some embodiments. Applications may be created quickly using a web browser through a rich library of drag-and-drop controls, for instance. An application can be connected to a single automation or multiple automations.

An action center (e.g., UiPath Action Center™) provides a straightforward and efficient mechanism to hand off processes from automations to humans, and vice versa. Humans may provide approvals or escalations, make exceptions, etc. The automation may then perform the automatic functionality of a given workflow.

A local assistant may be provided as a launchpad for users to launch automations (e.g., UiPath Assistant™). This functionality may be provided in a tray provided by an operating system, for example, and may allow users to interact with RPA robots and RPA robot-powered applications on their computing systems. An interface may list automations approved for a given user and allow the user to run them. These may include ready-to-go automation from an automation marketplace, an internal automation store in an automation hub, etc. When automations run, they may run as a local instance in parallel with other processes on the computing system so users can use the computing system while the automation performs its actions. In certain embodiments, the assistant is integrated with the task capture functionality such that users can document their soon-to-be-automated processes from the assistant launchpad.

Chatbots (e.g., UiPath Chatbots™), social messaging applications, an/or voice commands may enable users to run automations. This may simplify access to information, tools, and resources users need in order to interact with customers or perform other activities. Conversations between people may be readily automated, as with other processes. Trigger RPA robots kicked off in this manner may perform operations such as checking an order status, posting data in a CRM, etc., potentially using plain language commands.

End-to-end measurement and government of an automation program at any scale may be provided by hyper-automation system 100 in some embodiments. Per the above, analytics may be employed to understand the performance of automations (e.g., via UiPath Insights™). Data modeling and analytics using any combination of available business metrics and operational insights may be used for various automated processes. Custom-designed and pre-built dashboards allow data to be visualized across desired metrics, new analytical insights to be discovered, performance indicators to be tracked, ROI to be discovered for automations, telemetry monitoring to be performed on user computing systems, errors and anomalies to be detected, and automations to be debugged. An automation management console (e.g., UiPath Automation Ops™) may be provided to manage automations throughout the automation lifecycle. An organization may govern how automations are built, what users can do with them, and which automations users can access.

Hyper-automation system 100 provides an iterative platform in some embodiments. Processes can be discovered, automations can be built, tested, and deployed, performance may be measured, use of the automations may readily be provided to users, feedback may be obtained, AI/ML models may be trained and retrained, and the process may repeat itself. This facilitates a more robust and effective suite of automation.

In some embodiments, generative AI models are used. Generative AI can generate various types of content, such as text, imagery, audio, and synthetic data. various types of generative AI models may be used, including, but not limited to, large language models (LLMs), generative adversarial networks (GANs), variational autoencoders (VAEs), transformers, etc. These models may be part of AI/ML models 132 hosted on server 130. For instance, generative AI models may be trained on a large corpus of textual information to perform semantic understanding, to understand the nature of what is present on a screen from text, and the like. In certain embodiments, generative AI models 172 provided by an existing cloud ML service provider, such as OpenAI®, Google®, Amazon®, Microsoft®, IBM®, Nvidia®, Facebook®, etc., may be employed and trained to provide such functionality. In generative AI embodiments where generative AI model(s) 172 are remotely hosted, server 130 can be configured to integrate with third-party APIs, which allow server 130 to send a request to generative AI model(s) 172 including the requisite input information and receive a response in return (e.g., the semantic matches of fields between application versions, a classification of the type of the application on the screen, etc.). Such embodiments may provide a more advanced and sophisticated user experience, as well as provide access to state-of-the-art natural language processing (NLP) and other ML capabilities that these companies offer.

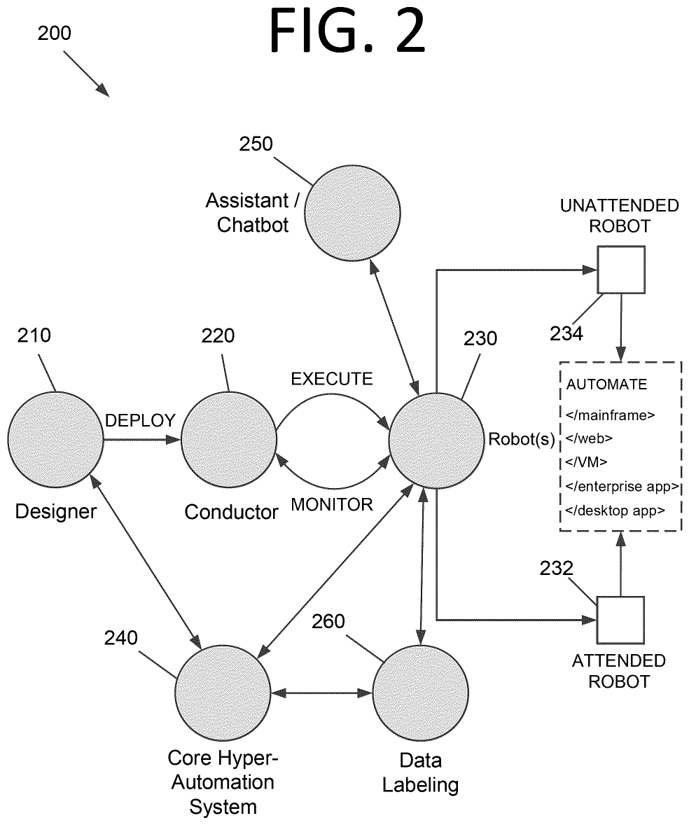

FIG. 2 is an architectural diagram illustrating an RPA system 200, according to an embodiment of the present invention. In some embodiments, RPA system 200 is part of hyper-automation system 100 of FIG. 1. RPA system 200 includes a designer 210 that allows a developer to design and implement workflows. Designer 210 may provide a solution for application integration, as well as automating third-party applications, administrative Information Technology (IT) tasks, and business IT processes. Designer 210 may facilitate development of an automation project, which is a graphical representation of a business process. Simply put, designer 210 facilitates the development and deployment of workflows and robots. In some embodiments, designer 210 may be an application that runs on a user's desktop, an application that runs remotely in a VM, a web application, etc.

The automation project enables automation of rule-based processes by giving the developer control of the execution order and the relationship between a custom set of steps developed in a workflow, defined herein as “activities” per the above. One commercial example of an embodiment of designer 210 is UiPath Studio™. Each activity may include an action, such as clicking a button, reading a file, writing to a log panel, etc. In some embodiments, workflows may be nested or embedded.

Some types of workflows may include, but are not limited to, sequences, flowcharts, Finite State Machines (FSMs), and/or global exception handlers. Sequences may be particularly suitable for linear processes, enabling flow from one activity to another without cluttering a workflow. Flowcharts may be particularly suitable for more complex business logic, enabling integration of decisions and connection of activities in a more diverse manner through multiple branching logic operators. FSMs may be particularly suitable for large workflows. FSMs may use a finite number of states in their execution, which are triggered by a condition (i.e., transition) or an activity. Global exception handlers may be particularly suitable for determining workflow behavior when encountering an execution error and for debugging processes.

Once a workflow is developed in designer 210, execution of business processes is orchestrated by conductor 220, which orchestrates one or more robots 230 that execute the workflows developed in designer 210. One commercial example of an embodiment of conductor 220 is UiPath Orchestrator™ Conductor 220 facilitates management of the creation, monitoring, and deployment of resources in an environment. Conductor 220 may act as an integration point with third-party solutions and applications. Per the above, in some embodiments, conductor 220 may be part of core hyper-automation system 120 of FIG. 1.

Conductor 220 may manage a fleet of robots 230, connecting and executing robots 230 from a centralized point. Types of robots 230 that may be managed include, but are not limited to, attended robots 232, unattended robots 234, development robots (similar to unattended robots 234, but used for development and testing purposes), and nonproduction robots (similar to attended robots 232, but used for development and testing purposes). Attended robots 232 are triggered by user events and operate alongside a human on the same computing system. Attended robots 232 may be used with conductor 220 for a centralized process deployment and logging medium. Attended robots 232 may help the human user accomplish various tasks, and may be triggered by user events. In some embodiments, processes cannot be started from conductor 220 on this type of robot and/or they cannot run under a locked screen. In certain embodiments, attended robots 232 can only be started from a robot tray or from a command prompt. Attended robots 232 should run under human supervision in some embodiments.

Unattended robots 234 run unattended in virtual environments and can automate many processes. Unattended robots 234 may be responsible for remote execution, monitoring, scheduling, and providing support for work queues. Debugging for all robot types may be run in designer 210 in some embodiments. Both attended and unattended robots may automate various systems and applications including, but not limited to, mainframes, web applications, VMs, enterprise applications (e.g., those produced by SAP®, SalesForce®, Oracle®, etc.), and computing system applications (e.g., desktop and laptop applications, mobile device applications, wearable computer applications, etc.).

Conductor 220 may have various capabilities including, but not limited to, provisioning, deployment, configuration, queueing, monitoring, logging, and/or providing interconnectivity. Provisioning may include creating and maintenance of connections between robots 230 and conductor 220 (e.g., a web application). Deployment may include assuring the correct delivery of package versions to assigned robots 230 for execution. Configuration may include maintenance and delivery of robot environments and process configurations. Queueing may include providing management of queues and queue items. Monitoring may include keeping track of robot identification data and maintaining user permissions. Logging may include storing and indexing logs to a database (e.g., a structured query language (SQL) database or a “not only” SQL (NoSQL) database) and/or another storage mechanism (e.g., ElasticSearch®, which provides the ability to store and quickly query large datasets). Conductor 220 may provide interconnectivity by acting as the centralized point of communication for third-party solutions and/or applications.

Robots 230 are execution agents that implement workflows built in designer 210. One commercial example of some embodiments of robot(s) 230 is UiPath Robots™. In some embodiments, robots 230 install the Microsoft Windows® Service Control Manager (SCM)—managed service by default. As a result, such robots 230 can open interactive Windows® sessions under the local system account, and have the rights of a Windows® service.

In some embodiments, robots 230 can be installed in user mode. For such robots 230, this means they have the same rights as the user under which a given robot 230 has been installed. This feature may also be available for High Density (HD) robots, which ensure full utilization of each machine at its maximum potential. In some embodiments, any type of robot 230 may be configured in an HD environment.

Robots 230 in some embodiments are split into several components, each being dedicated to a particular automation task. The robot components in some embodiments include, but are not limited to, SCM-managed robot services, user mode robot services, executors, agents, and command line. SCM-managed robot services manage and monitor Windows® sessions and act as a proxy between conductor 220 and the execution hosts (i.e., the computing systems on which robots 230 are executed). These services are trusted with and manage the credentials for robots 230. A console application is launched by the SCM under the local system.

User mode robot services in some embodiments manage and monitor Windows® sessions and act as a proxy between conductor 220 and the execution hosts. User mode robot services may be trusted with and manage the credentials for robots 230. A Windows® application may automatically be launched if the SCM-managed robot service is not installed.

Executors may run given jobs under a Windows® session (i.e., they may execute workflows. Executors may be aware of per-monitor dots per inch (DPI) settings. Agents may be Windows® Presentation Foundation (WPF) applications that display the available jobs in the system tray window. Agents may be a client of the service. Agents may request to start or stop jobs and change settings. The command line is a client of the service. The command line is a console application that can request to start jobs and waits for their output.

Having components of robots 230 split as explained above helps developers, support users, and computing systems more easily run, identify, and track what each component is executing. Special behaviors may be configured per component this way, such as setting up different firewall rules for the executor and the service. The executor may always be aware of DPI settings per monitor in some embodiments. As a result, workflows may be executed at any DPI, regardless of the configuration of the computing system on which they were created. Projects from designer 210 may also be independent of browser zoom level in some embodiments. For applications that are DPI-unaware or intentionally marked as unaware, DPI may be disabled in some embodiments.

RPA system 200 in this embodiment is part of a hyper-automation system. Developers may use designer 210 to build and test RPA robots that utilize AI/ML models deployed in core hyper-automation system 240 (e.g., as part of an AI center thereof). Such RPA robots may send input for execution of the AI/ML model(s) and receive output therefrom via core hyper-automation system 240.

One or more robots 230 may be listeners, as described above. These listeners may provide information to core hyper-automation system 240 regarding what users are doing when they use their computing systems. This information may then be used by core hyper-automation system for process mining, task mining, task capture, etc.

An assistant/chatbot 250 may be provided on user computing systems to allow users to launch RPA local robots. The assistant may be located in a system tray, for example. Chatbots may have a user interface so users can see text in the chatbot. Alternatively, chatbots may lack a user interface and run in the background, listening using the computing system's microphone for user speech.

In some embodiments, data labeling may be performed by a user of the computing system on which a robot is executing or on another computing system that the robot provides information to. For instance, if a robot calls an AI/ML model that performs CV on images for VM users, but the AI/ML model does not correctly identify a button on the screen, the user may draw a rectangle around the misidentified or non-identified component and potentially provide text with a correct identification. This information may be provided to core hyper-automation system 240 and then used later for training a new version of the AI/ML model.

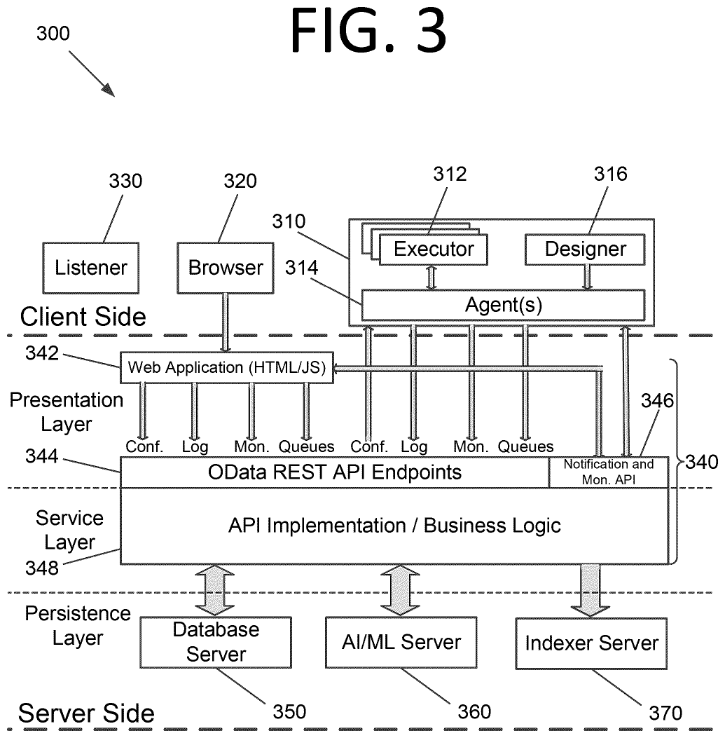

FIG. 3 is an architectural diagram illustrating a deployed RPA system 300, according to an embodiment of the present invention. In some embodiments, RPA system 300 may be a part of RPA system 200 of FIG. 2 and/or hyper-automation system 100 of FIG. 1. Deployed RPA system 300 may be a cloud-based system, an on-premises system, a desktop-based system that offers enterprise level, user level, or device level automation solutions for automation of different computing processes, etc.

It should be noted that the client side, the server side, or both, may include any desired number of computing systems without deviating from the scope of the invention. On the client side, a robot application 310 includes executors 312, an agent 314, and a designer 316. However, in some embodiments, designer 316 may not be running on the same computing system as executors 312 and agent 314. Executors 312 are running processes. Several business projects may run simultaneously, as shown in FIG. 3. Agent 314 (e.g., a Windows® service) is the single point of contact for all executors 312 in this embodiment. All messages in this embodiment are logged into conductor 340, which processes them further via database server 350, an AI/ML server 360, an indexer server 370, or any combination thereof. As discussed above with respect to FIG. 2, executors 312 may be robot components.

In some embodiments, a robot represents an association between a machine name and a username. The robot may manage multiple executors at the same time. On computing systems that support multiple interactive sessions running simultaneously (e.g., Windows® Server 2012), multiple robots may be running at the same time, each in a separate Windows® session using a unique username. This is referred to as HD robots above.

Agent 314 is also responsible for sending the status of the robot (e.g., periodically sending a “heartbeat” message indicating that the robot is still functioning) and downloading the required version of the package to be executed. The communication between agent 314 and conductor 340 is always initiated by agent 314 in some embodiments. In the notification scenario, agent 314 may open a WebSocket channel that is later used by conductor 340 to send commands to the robot (e.g., start, stop, etc.).

A listener 330 monitors and records data pertaining to user interactions with an attended computing system and/or operations of an unattended computing system on which listener 330 resides. Listener 330 may be an RPA robot, part of an operating system, a downloadable application for the respective computing system, or any other software and/or hardware without deviating from the scope of the invention. Indeed, in some embodiments, the logic of the listener is implemented partially or completely via physical hardware.

On the server side, a presentation layer (web application 342, Open Data Protocol (OData) Representative State Transfer (REST) Application Programming Interface (API) endpoints 344, and notification and monitoring 346), a service layer (API implementation/business logic 348), and a persistence layer (database server 350, AI/ML server 360, and indexer server 370) are included. Conductor 340 includes web application 342, OData REST API endpoints 344, notification and monitoring 346, and API implementation/business logic 348. In some embodiments, most actions that a user performs in the interface of conductor 340 (e.g., via browser 320) are performed by calling various APIs. Such actions may include, but are not limited to, starting jobs on robots, adding/removing data in queues, scheduling jobs to run unattended, etc. without deviating from the scope of the invention. Web application 342 is the visual layer of the server platform. In this embodiment, web application 342 uses Hypertext Markup Language (HTML) and JavaScript (JS). However, any desired markup languages, script languages, or any other formats may be used without deviating from the scope of the invention. The user interacts with web pages from web application 342 via browser 320 in this embodiment in order to perform various actions to control conductor 340. For instance, the user may create robot groups, assign packages to the robots, analyze logs per robot and/or per process, start and stop robots, etc.

In addition to web application 342, conductor 340 also includes a service layer that exposes OData REST API endpoints 344. However, other endpoints may be included without deviating from the scope of the invention. The REST API is consumed by both web application 342 and agent 314. Agent 314 is the supervisor of one or more robots on the client computer in this embodiment.

The REST API in this embodiment covers configuration, logging, monitoring, and queueing functionality. The configuration endpoints may be used to define and configure application users, permissions, robots, assets, releases, and environments in some embodiments. Logging REST endpoints may be used to log different information, such as errors, explicit messages sent by the robots, and other environment-specific information, for instance. Deployment REST endpoints may be used by the robots to query the package version that should be executed if the start job command is used in conductor 340. Queueing REST endpoints may be responsible for queues and queue item management, such as adding data to a queue, obtaining a transaction from the queue, setting the status of a transaction, etc.

Monitoring REST endpoints may monitor web application 342 and agent 314. Notification and monitoring API 346 may be REST endpoints that are used for registering agent 314, delivering configuration settings to agent 314, and for sending/receiving notifications from the server and agent 314. Notification and monitoring API 346 may also use WebSocket communication in some embodiments.

The APIs in the service layer may be accessed through configuration of an appropriate API access path in some embodiments, e.g., based on whether conductor 340 and an overall hyper-automation system have an on-premises deployment type or a cloud-based deployment type. APIs for conductor 340 may provide custom methods for querying stats about various entities registered in conductor 340. Each logical resource may be an OData entity in some embodiments. In such an entity, components such as the robot, process, queue, etc., may have properties, relationships, and operations. APIs of conductor 340 may be consumed by web application 342 and/or agents 314 in two ways in some embodiments: by getting the API access information from conductor 340, or by registering an external application to use the OAuth flow.

The persistence layer includes a trio of servers in this embodiment-database server 350 (e.g., a SQL server), AI/ML server 360 (e.g., a server providing AI/ML model serving services, such as AI center functionality) and indexer server 370. Database server 350 in this embodiment stores the configurations of the robots, robot groups, associated processes, users, roles, schedules, etc. This information is managed through web application 342 in some embodiments. Database server 350 may manage queues and queue items. In some embodiments, database server 350 may store messages logged by the robots (in addition to or in lieu of indexer server 370). Database server 350 may also store process mining, task mining, and/or task capture-related data, received from listener 330 installed on the client side, for example. While no arrow is shown between listener 330 and database 350, it should be understood that listener 330 is able to communicate with database 350, and vice versa in some embodiments. This data may be stored in the form of PDDs, images, XAML files, etc. Listener 330 may be configured to intercept user actions, processes, tasks, and performance metrics on the respective computing system on which listener 330 resides. For example, listener 330 may record user actions (e.g., clicks, typed characters, locations, applications, active elements, times, etc.) on its respective computing system and then convert these into a suitable format to be provided to and stored in database server 350.

AI/ML server 360 facilitates incorporation of AI/ML models into automations. Pre-built AI/ML models, model templates, and various deployment options may make such functionality accessible even to those who are not data scientists. Deployed automations (e.g., RPA robots) may call AI/ML models from AI/ML server 360. Performance of the AI/ML models may be monitored, and be trained and improved using human-validated data. AI/ML server 360 may schedule and execute training jobs to train new versions of the AI/ML models.

AI/ML server 360 may store data pertaining to AI/ML models and ML packages for configuring various ML skills for a user at development time. An ML skill, as used herein, is a pre-built and trained ML model for a process, which may be used by an automation, for example. AI/ML server 360 may also store data pertaining to document understanding technologies and frameworks, algorithms and software packages for various AI/ML capabilities including, but not limited to, intent analysis, natural language processing (NLP), speech analysis, different types of AI/ML models, etc.

Indexer server 370, which is optional in some embodiments, stores and indexes the information logged by the robots. In certain embodiments, indexer server 370 may be disabled through configuration settings. In some embodiments, indexer server 370 uses ElasticSearch®, which is an open source project full-text search engine. Messages logged by robots (e.g., using activities like log message or write line) may be sent through the logging REST endpoint(s) to indexer server 370, where they are indexed for future utilization.

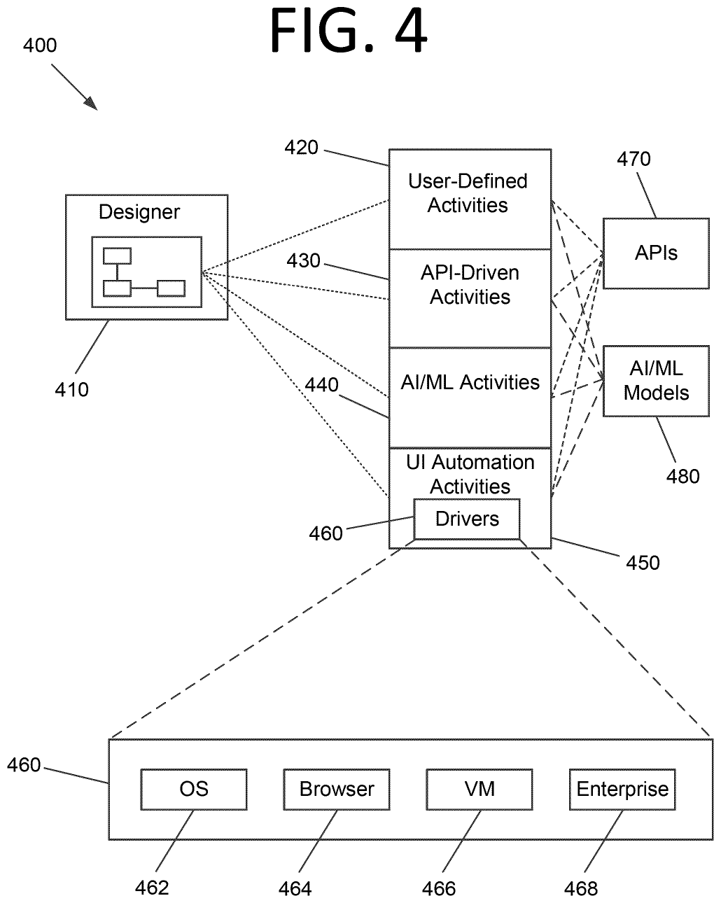

FIG. 4 is an architectural diagram illustrating the relationship 400 between a designer 410, activities 420, 430, 440, 450, drivers 460, APIs 470, and AI/ML models 480, according to an embodiment of the present invention. Per the above, a developer uses designer 410 to develop workflows that are executed by robots. The various types of activities may be displayed to the developer in some embodiments. Designer 410 may be local to the user's computing system or remote thereto (e.g., accessed via VM or a local web browser interacting with a remote web server). Workflows may include user-defined activities 420, API-driven activities 430, AI/ML activities 440, and/or UI automation activities 450. User-defined activities 420 and API-driven activities 440 interact with applications via their APIs. User-defined activities 420 and/or AI/ML activities 440 may call one or more AI/ML models 480 in some embodiments, which may be located locally to the computing system on which the robot is operating and/or remotely thereto.

Some embodiments are able to identify non-textual visual components in an image, which is called CV herein. CV may be performed at least in part by AI/ML model(s) 480. Some CV activities pertaining to such components may include, but are not limited to, extracting of text from segmented label data using OCR, fuzzy text matching, cropping of segmented label data using ML, comparison of extracted text in label data with ground truth data, etc. In some embodiments, there may be hundreds or even thousands of activities that may be implemented in user-defined activities 420. However, any number and/or type of activities may be used without deviating from the scope of the invention.

UI automation activities 450 are a subset of special, lower-level activities that are written in lower-level code and facilitate interactions with the screen. UI automation activities 450 facilitate these interactions via drivers 460 that allow the robot to interact with the desired software. For instance, drivers 460 may include operating system (OS) drivers 462, browser drivers 464, VM drivers 466, enterprise application drivers 468, etc. One or more of AI/ML models 480 may be used by UI automation activities 450 in order to perform interactions with the computing system in some embodiments. In certain embodiments, AI/ML models 480 may augment drivers 460 or replace them completely. Indeed, in certain embodiments, drivers 460 are not included.

Drivers 460 may interact with the OS at a low level looking for hooks, monitoring for keys, etc. via OS drivers 462. Drivers 460 may facilitate integration with Chrome®, IER, Citrix®, SAP®, etc. For instance, the “click” activity performs the same role in these different applications via drivers 460.

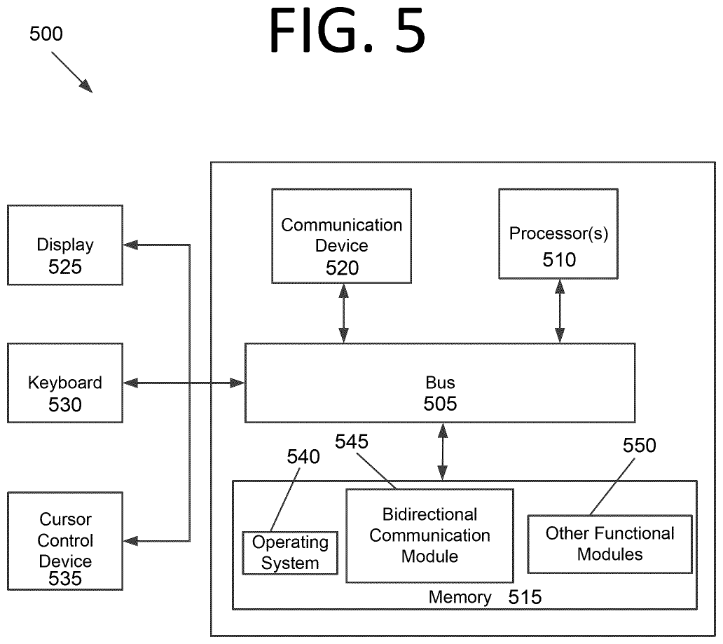

FIG. 5 is an architectural diagram illustrating a computing system 500 configured to provide a design time AI/ML recommendation engine for RPA, according to an embodiment of the present invention. In some embodiments, computing system 500 may be one or more of the computing systems depicted and/or described herein. In certain embodiments, computing system 500 may be part of a hyper-automation system, such as that shown in FIGS. 1 and 2. Computing system 500 includes a bus 505 or other communication mechanism for communicating information, and processor(s) 510 coupled to bus 505 for processing information. Processor(s) 510 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 510 may also have multiple processing cores, and at least some of the cores may be configured to perform specific functions. Multi-parallel processing may be used in some embodiments. In certain embodiments, at least one of processor(s) 510 may be a neuromorphic circuit that includes processing elements that mimic biological neurons. In some embodiments, neuromorphic circuits may not require the typical components of a Von Neumann computing architecture.

Computing system 500 further includes a memory 515 for storing information and instructions to be executed by processor(s) 510. Memory 515 can be comprised of any combination of random access memory (RAM), read-only memory (ROM), flash memory, cache, static storage such as a magnetic or optical disk, or any other types of non-transitory computer-readable media or combinations thereof. Non-transitory computer-readable media may be any available media that can be accessed by processor(s) 510 and may include volatile media, non-volatile media, or both. The media may also be removable, non-removable, or both. Computing system 500 includes a communication device 520, such as a transceiver, to provide access to a communications network via a wireless and/or wired connection. In some embodiments, communication device 520 may include one or more antennas that are singular, arrayed, phased, switched, beamforming, beamsteering, a combination thereof, and or any other antenna configuration without deviating from the scope of the invention.

Processor(s) 510 are further coupled via bus 505 to a display 525. Any suitable display device and haptic I/O may be used without deviating from the scope of the invention.

A keyboard 530 and a cursor control device 535, such as a computer mouse, a touchpad, etc., are further coupled to bus 505 to enable a user to interface with computing system 500. However, in certain embodiments, a physical keyboard and mouse may not be present, and the user may interact with the device solely through display 525 and/or a touchpad (not shown). Any type and combination of input devices may be used as a matter of design choice. In certain embodiments, no physical input device and/or display is present. For instance, the user may interact with computing system 500 remotely via another computing system in communication therewith, or computing system 500 may operate autonomously.

Memory 515 stores software modules that provide functionality when executed by processor(s) 510. The modules include an operating system 540 for computing system 500. The modules further include an AI/ML recommendation engine model 545 that is configured to perform all or part of the AI/ML processes described herein or derivatives thereof. Computing system 500 may include one or more additional functional modules 550 that include additional functionality.

One skilled in the art will appreciate that a “system” could be embodied as a server, an embedded computing system, a personal computer, a console, a personal digital assistant (PDA), a cell phone, a tablet computing device, a quantum computing system, or any other suitable computing device, or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems. The computing system could be part of or otherwise accessible by a local area network (LAN), a mobile communications network, a satellite communications network, the Internet, a public or private cloud, a hybrid cloud, a server farm, any combination thereof, etc. Any localized or distributed architecture may be used without deviating from the scope of the invention.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

### Robot Realtime Communication Architecture

In some embodiments, the robot real-time communication architecture for both attended and unattended modes includes a Start Trigger component, an App Request Trigger component, a Handle App Request component, and a Stop Trigger component.

In some embodiments, Start Trigger component enables the triggers available in the workflows (i.e., sub-processes). For example, when the trigger is a mouse click, then Start Trigger component is initiated upon execution of the process (i.e., the primary workflow or main process). The Start Trigger component in this embodiment enables all triggers that are available for sub-process (i.e., workflows) of the primary workflow or main process.

The App Request Trigger component monitors for an ‘invoke workflow request’ message, which is transmitted from the web application. The ‘invoke workflow request’ in this embodiment is a request for the robot to execute a workflow on a running process (i.e., the primary workflow) with the available XAML name and input arguments received from the web application.

The Handle App Request component receives an ‘invoke workflow payload’ message. This message may include XAML name and input arguments. The ‘invoke workflow payload’ message causes the Handle App Request component to parse the inputs to invoke a corresponding workflow (i.e., a sub-process) and return workflow results to the web application, when the sub-process is completed.

The Stop Trigger component may disable all the running triggers. This may happen only for certain conditions called Stop conditions. The Stop conditions are different for both attended and unattended processes. One example for Stop condition in attended mode is, if the web application is closed from a browser and the communication between the web application and the robot is terminated for more than a specific time, then the Stop Trigger component is initiated and terminates the process. This is one of the stop conditions. The Stop Trigger component in some embodiments may also be initiated by a user message.

Any request (or message) that is received by the App Request Trigger component may be triggered, initiating the corresponding sub-processes/workflow by the Handle App Request component using the inputs. It should be noted that the architecture is the same irrespective of whether the automation is attended or unattended. However, the difference is how the communication works between the web application and the robot.

For an attended mode, the communication uses IPC (Interprocess Communication) channels with the help of a JavaScript™ component called RobotJS. For explanation purposes. IPC is a set of techniques used by operating systems and software applications to enable communication and data exchange between separate processes or programs running on the same computer or across a network. IPC mechanisms include pipes, shared memory, message passing, and synchronization primitives. IPC facilitates sharing information, coordinating activities, and passing data between processes. For an unattended mode, the communication is carried out over a SignalR channel, which enables remote connection through WebSocket™ and other web technologies.

### Attended Automation Implementation

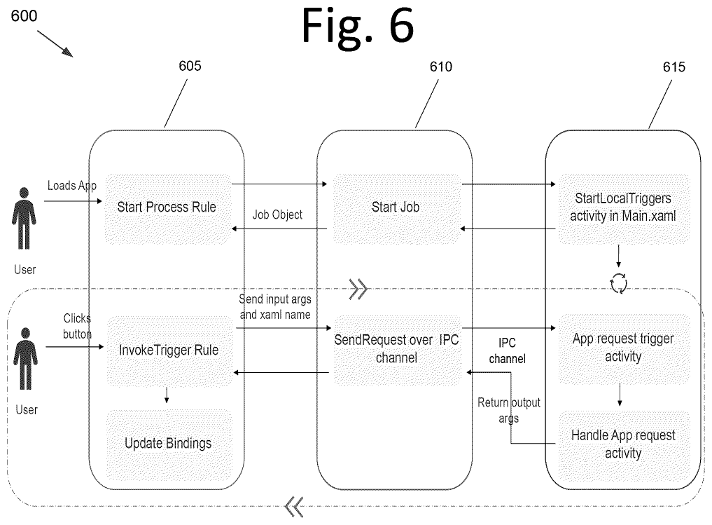

FIG. 6 is a diagram illustrating a system 600 for real-time communication by an attended robot, according to an embodiment of the present invention. In some embodiments, system 600 is configured to facilitate communication between a web application 605, a RobotJS 610, and a robot 615.

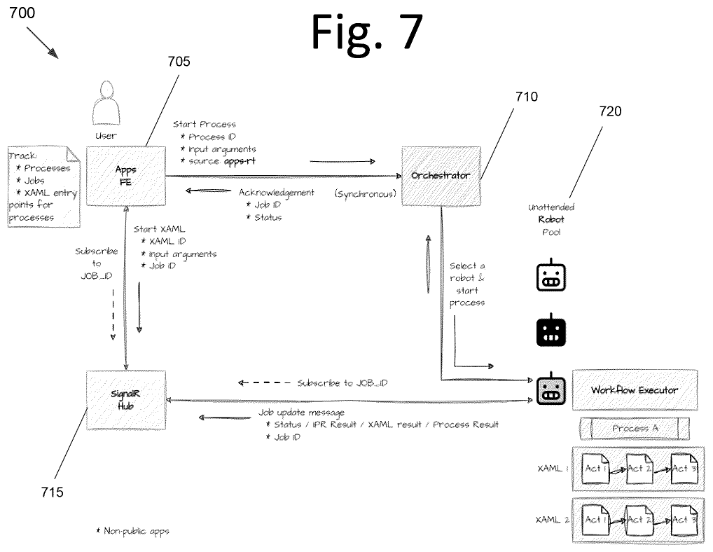

In embodiments that use attended mode, robot 615 runs on the same physical machine as web application 605 and RobotJS 610. Additionally, web application 605 and robot 615 are communicated by way of RobotJS 610 and attended processes are directly invoked by web application 605 on robot 615. This is opposite to the unattended mode, where Orchestrator™ works as a mediator and relays the process start command to a remote robot. See, for example, FIG. 7.

RobotJS 610 is a JavaScript™ component, which is attached to any web application. In certain embodiments, web application 605 is a web client. In those embodiments, RobotJS 610 is attached to web application 605, allowing web application 605 to communicate with robot 615 (e.g., Local Robots running on the same system) using App Request Trigger component and Handle App Request component activities via the IPC channel.

In FIG. 6, web application 605 submits a request to robot 615 for initiating a primary workflow. The request is communicated through RobotJS 610 in this example. The Start Trigger component in this embodiment may now enable all triggers, which would be available for any sub-process (i.e., workflows) of the primary workflow.

Now that the triggers are activated and running, when a user clicks on a button through web application 605, an ‘invoke trigger rule’ is activated. The ‘invoke trigger rule’ may then pull input arguments and XAML name associated with the sub-process of the primary workflow. Web application 605 transmits an App Request containing the input argument and the XAML name to robot 615 by way of RobotJS 610. RobotJS 610 may send App Request to robot 615 over IPC channel.

Handle App Request component of Robot 615 receives the App Request message. This message, which includes XAML name and input arguments, causes the Handle App Request component to parse the inputs to invoke a corresponding sub-workflow (i.e., a sub-process) and return sub-workflow results to web application 605 by way of RobotJS 610. More specifically, robot 615 may send back the results (or output arguments) of the sub-workflow back to web application 605.

Once the sub-process execution is complete and the results are sent back to web application 605, the results are bound to the one or more elements of web application 605 to display the output to the user in a readable format. In this example, the results are displayed in web application 605 using various controls such as table, dropdown, label, etc.

It should be appreciated that the primary workflow runs and continues to listen to various triggers from web application 605. In certain embodiments, the primary workflow can be stopped either by closing web application 605 or by invoking a workflow that stops the triggers and closes the primary workflow. Once the primary workflow is closed, all the triggers associated with the primary workflow are terminated.

### Unattended Automation Implementation

FIG. 7 is a diagram illustrating a system 700 for real-time communication by an unattended robot, according to an embodiment of the present invention.

In this embodiment, user equipment (or machine) includes an application (or application FE (front end) 705. Application FE may be referred to as a web application accessed by the end user. Application 705 includes tracking data such as processes, jobs, XAML entry points for the processes, etc. To start the process, web application 705 initiates a request to orchestrator 710. The request to start the process includes a process ID identifying which process to start, input arguments for the process, and a source (e.g., apps-rt).

Because robot 720 is on a separate (or remote) machine not associated with user equipment, robotJS is not utilized in this embodiment. Instead, web application 705 and robot 720 communicate by way of SignalR Hub 715, while orchestrator 710 helps initiate (or start) the process (Process A in this example) execution by identifying and selecting an available robot 720. Orchestrator 710 may identify robot 720 and instruct robot 720 to start the main process (or main workflow). Once the main process is executed by robot 720, an acknowledgement (including Job ID and status) is sent to orchestrator 710. Orchestrator 710 then returns the status of the process execution (as an acknowledgement with Job ID) to web application 705.

It should be appreciated that robot 720 executing the process may execute the process on the cloud, a virtual machine, or any other remote location. The process may start executing the ‘Start Trigger’ component, which enables all triggers available in the sub-processes. This allows robot 720 to keep the process running while waiting for additional instructions for sub-processes.

Once the process has begun, a new SignalR Hub channel is established for communication between web application (i.e., application FE) 705 and robot 720. In this embodiment, SignalR Hub channel works as a bi-directional communication channel between web application 705 and remote unattended robot 720 for exchange of messages. Once SignalR Hub channel is established, both web application 705 and robot 720 listen for incoming messages from each other based on the Job ID, which was shared earlier in the process. Web application 705 utilizes this SignalR Hub channel to initiate subprocess/workflows (e.g., XAML 1, XAML 2, etc.) based on the trigger events and inputs (e.g., XAML ID, input arguments and Job ID) using the App Request Trigger component and the Handle App Request component activities to find the right workflow and execute the right workflow. Accordingly, robot 720 utilizes this same SignalR channel to send back output from the sub processes to the web application 705.

In some embodiments, web application 705 may transmit a request containing a XAML ID, input arguments, and job ID for a sub-processes of the main processes to SignalR Hub 715. SignalR Hub 715 may communicate this request to robot 720 in order for robot 720 to execute the sub-processes. Robot 720 may return a job update message containing a status of the sub-processes, intermediate result, XAML workflow results, or a process completion result, along with a job ID. This job update message is received by SignalR Hub 715 and returned to web application 705.

In the event that web application 705 is closed, the SignalR Hub channel is closed disconnecting web application 705 from robot 720. In some embodiments, stop trigger is activated when there is no active communication between web application 705 and Robot 720 for a specified duration of time and the main process is terminated along with all sub-processes and triggers.

It should be noted that workflow executor is part of Robot 720 which executes the workflow.

It may be noted here that SignalR Hub 715 is a communication hub that connects multiple entities over SignalR channels and exchanges one or more messages. In this embodiment, web application 705 and unattended robot 720, which is on a remote machine, are connected through a SignalR channel and exchange messages to run workflows (including sub-processes) and obtains the results. Web application 705 sends a message to initiate a sub-process, and after execution of the sub process, robot 720 sends message back with results.

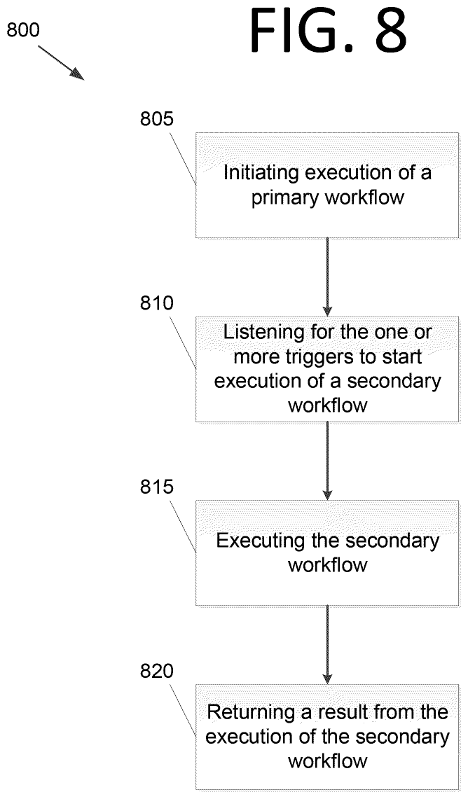

FIG. 8 is a flow diagram illustrating a process 800 for performing real-time bidirectional communication between RPA robots and a web application, according to an embodiment of the present invention. In some embodiments, bidirectional communication module 545 of computing system 500 may execute process 800. In those embodiments, process 800 includes initiating at 805 execution of a primary workflow when a request is received from a web application, wherein the robot is in an attended mode or an unattended mode. At 810, process 800 includes listening for one or more triggers from the web application to start execution of a secondary workflow. At 815, process 800 includes executing the secondary workflow when the one or more triggers are detected, and at 820, process 800 includes returning a result of the execution of the secondary workflow to the web application. The communication between the robot and the web application is instantaneous and bi-directional.

The process steps performed in FIG. 8 may be performed by a computer program, encoding instructions for the processor(s) to perform at least part of the process(es) described in FIG. 8, in accordance with embodiments of the present invention. The computer program may be embodied on a non-transitory computer-readable medium. The computer-readable medium may be, but is not limited to, a hard disk drive, a flash device, RAM, a tape, and/or any other such medium or combination of media used to store data. The computer program may include encoded instructions for controlling processor(s) of a computing system (e.g., processor(s) 510 of computing system 500 of FIG. 5) to implement all or part of the process steps described in FIGS. 9 and 10, which may also be stored on the computer-readable medium.

The computer program can be implemented in hardware, software, or a hybrid implementation. The computer program can be composed of modules that are in operative communication with one another, and which are designed to pass information or instructions to display. The computer program can be configured to operate on a general purpose computer, an ASIC, or any other suitable device.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. One or more non-transitory computer-readable media storing one or more computer programs, the one or more computer programs configured to cause at least one processor to:
initiating, by a robot, execution of a primary workflow when a request is received from a web application, wherein the robot is in an attended mode or an unattended mode;
listening, by the robot, for one or more triggers from the web application to start execution of a secondary workflow;
executing, by the robot, the secondary workflow when the one or more triggers are detected; and
returning, by the robot, a result of the execution of the secondary workflow to the web application, wherein
communication between the robot and the web application is instantaneous and bi-directional.

2. The one or more non-transitory computer-readable media of claim 1, wherein the one or more computer programs is further configured to cause at least one processor to
receiving, by the robot, the request from a web application to initiate execution of the primary workflow.

3. The one or more non-transitory computer-readable media of claim 2, wherein the one or more computer programs is further configured to cause at least one processor to
upon execution of the primary workflow, enabling, by the robot, the one or more triggers, each of the one or more triggers associated with one or more corresponding secondary workflows.

4. The one or more non-transitory computer-readable media of claim 1, wherein the one or more computer programs is further configured to cause at least one processor to
receiving, by the robot, input arguments and a XAML name associated with the secondary workflow from the web application by way of an Interprocess Communication channel.

5. The one or more non-transitory computer-readable media of claim 1, wherein the one or more computer programs is further configured to cause at least one processor to
continuing to execute the primary workflow and to listen for the one or more triggers from the web application after returning the result of the execution of the secondary workflow to the web application.

6. The one or more non-transitory computer-readable media of claim 1, wherein the one or more computer programs is further configured to cause at least one processor to
receiving, by Orchestrator™, the request from a web application to initiate execution of the primary workflow;
identifying and selecting, by the Orchestrator™, the robot for execution of the primary process;
receiving, by the Orchestrator™, an acknowledgement comprising of job identification and status from the robot; and
forwarding, by the Orchestrator™, the status from the robot to the web application.

7. The one or more non-transitory computer-readable media of claim 6, wherein the one or more computer programs is further configured to cause at least one processor to
establishing a SignalR Hub channel between the web application and the robot for creating the bi-directional and instantaneous communication.

8. An apparatus, comprising:
at least one processor; and
memory comprising a set of instructions, wherein
the set of instructions are configured to cause the at least one processor to execute:
initiating, by a robot, execution of a primary workflow when a request is received from a web application, wherein the robot is in an attended mode or an unattended mode;
listening, by the robot, for one or more triggers from the web application to start execution of a secondary workflow;
executing, by the robot, the secondary workflow when the one or more triggers are detected; and
returning, by the robot, a result of the execution of the secondary workflow to the web application, wherein
communication between the robot and the web application is instantaneous and bi-directional.

9. The apparatus of claim 8, wherein the one or more computer programs is further configured to cause at least one processor to execute
receiving, by the robot, the request from a web application to initiate execution of the primary workflow.

10. The apparatus of claim 9, wherein the one or more computer programs is further configured to cause at least one processor to execute
upon execution of the primary workflow, enabling, by the robot, the one or more triggers, each of the one or more triggers associated with one or more corresponding secondary workflows.

11. The apparatus of claim 8, wherein the one or more computer programs is further configured to cause at least one processor to execute
receiving, by the robot, input arguments and a XAML name associated with the secondary workflow from the web application by way of an Interprocess Communication channel.

12. The apparatus of claim 8, wherein the one or more computer programs is further configured to cause at least one processor to execute
continuing to execute the primary workflow and to listen for the one or more triggers from the web application after returning the result of the execution of the secondary workflow to the web application.

13. The apparatus of claim 8, wherein the one or more computer programs is further configured to cause at least one processor to execute
receiving, by Orchestrator™, the request from a web application to initiate execution of the primary workflow;
identifying and selecting, by the Orchestrator™, the robot for execution of the primary process;
receiving, by the Orchestrator™, an acknowledgement comprising of job identification and status from the robot; and
forwarding, by the Orchestrator™, the status from the robot to the web application.

14. The apparatus of claim 13, wherein the one or more computer programs is further configured to cause at least one processor to execute
establishing a SignalR Hub channel between the web application and the robot for creating the bi-directional and instantaneous communication.

15. A computer-implemented method, comprising:
initiating, by a robot, execution of a primary workflow when a request is received from a web application, wherein the robot is in an attended mode or an unattended mode;
listening, by the robot, for one or more triggers from the web application to start execution of a secondary workflow;
executing, by the robot, the secondary workflow when the one or more triggers are detected; and
returning, by the robot, a result of the execution of the secondary workflow to the web application, wherein
communication between the robot and the web application is instantaneous and bi-directional.

16. The computer-implemented method of claim 15, further comprising:
receiving, by the robot, the request from a web application to initiate execution of the primary workflow.

17. The computer-implemented method of claim 16, further comprising:
upon execution of the primary workflow, enabling, by the robot, the one or more triggers, each of the one or more triggers associated with one or more corresponding secondary workflows.

18. The computer-implemented method of claim 15, further comprising:
receiving, by the robot, input arguments and a XAML name associated with the secondary workflow from the web application by way of an Interprocess Communication channel.

19. The computer-implemented method of claim 15, further comprising:
continuing to execute the primary workflow and to listen for the one or more triggers from the web application after returning the result of the execution of the secondary workflow to the web application.

20. The computer-implemented method of claim 15, further comprising:
receiving, by Orchestrator™, the request from a web application to initiate execution of the primary workflow;
identifying and selecting, by the Orchestrator™, the robot for execution of the primary process;
receiving, by the Orchestrator™, an acknowledgement comprising of job identification and status from the robot; and
forwarding, by the Orchestrator™, the status from the robot to the web application.

21. The computer-implemented method of claim 20, further comprising:
establishing a SignalR Hub channel between the web application and the robot for creating the bi-directional and instantaneous communication.
